(19) United States
(12) Patent Application Publication
(10) Pub. No.: US 2008/0310019 A1
(43) Pub. Date: Dec. 18, 2008

(54) REFRACTIVE INDEX DECREMENT FILM, POLARIZING MEMBER HAVING THE SAME AND DISPLAY DEVICE HAVING THE SAME

(76) Inventors: Yoon-sung UM, Yongin-si (KR); Jae-jin Lyu, Yongin-si (KR); Seung-beom Park, Seoul (KR); Jin-won Park, Suwon-si (KR); Hoon Kim, Ansan-si (KR); Hye-ran You, Yongin-si (KR)

Correspondence Address: F. CHAU & ASSOCIATES, LLC, 130 WOODBURY ROAD, WOODBURY, NY, 11797, US

(21) Appl. No.: 12/131,720

(22) Filed: Jun. 2, 2008

(30) Foreign Application Priority Data
Jun. 14, 2007 (KR) 10-2007-0058415

(51) Int. Cl. G02B 27/28; G02B 1/10

(52) U.S. Cl. 359/485; 359/580

(57) ABSTRACT

A refractive index decrement film, includes: a transparent base layer; a plurality of refraction decreasing layers that is formed on the base layer and has different refractive indices, where the refraction decreasing layers closer to the base layer have a relatively high refractive index and the refraction decreasing layers farther from the base layer have a relatively low refractive index.

### CROSS-REFERENCE TO RELATED APPLICATION

This application claims priority from Korean Patent Application No. 10-2007-0058415, filed on Jun. 14, 2007, in the Korean Intellectual Property Office, the disclosure of which is incorporated herein by reference.

### BACKGROUND OF THE INVENTION

1. Technical Field

Apparatus consistent with the present disclosure relates to a refractive index decrement film, a polarizing member having the same, and a display device having the same and, more particularly, to a refractive index decrement film that decreases a reflection rate of light, a polarizing member having the same, and a display device having the same.

2. Discussion of Related Art

Among various kinds of display devices, the cathode ray tube (CRT) has been replaced by flat panel displays that are being made possible with the rapid advancements in various technologies. The flat panel displays include a liquid crystal display (LCD) panel, a plasma display panel (PDP), an organic light emitting diode display (OLED) panel and a field emission display (FED) panel. More specifically, the LCD panel is small, light and consumes less power, and has been incorporated into almost every information processing device, from small devices such as a mobile phone, a personal digital assistant (PDA) and a portable multimedia player (PMP) to medium and large-size devices such as video monitors and TVs.

The LCD device has such a problem, however, in that a contrast ratio of an image is deteriorated by external light reflecting from a surface of the display panel that is displaying an image.

### SUMMARY OF THE INVENTION

Accordingly, an exemplary embodiment of the present invention provides a refractive index decrement film that decreases a reflection rate of light.

Also, an exemplary embodiment of the present invention provides a polarizing member that comprises the refractive index decrement film.

Further, an exemplary embodiment of the present invention provides a display device that comprises one of the refractive index decrement film and the polarizing member to reduce a decrease in contrast ratio.

Additional aspects and/or advantages provided by exemplary embodiments of the present invention will be set forth in part in the description which follows and, in part, will be obvious from the description, or may be learned by practice of the present invention.

The foregoing and/or other aspects provided by exemplary embodiments of the present invention are also achieved by providing a refractive index decrement film, including: a transparent base layer; a plurality of refraction decreasing layers that is formed on the base layer and has different refractive indices, and the refraction decreasing layers closer to the base layer have a relatively high refractive index while the refraction decreasing layers farther from the base layer have a relatively low refractive index.

According to an exemplary embodiment of the present invention, the refraction decreasing layers have a porous structure.

In an exemplary embodiment of the present invention, the refraction decreasing layers closer to the base layer have a relatively low density of pores, while the refraction decreasing layers farther from the base layer have a relatively high density of pores.

According to an exemplary embodiment of the present invention, the pores of the refraction decreasing layers are filled with at least one of air and an inert gas.

According to an exemplary embodiment of the present invention, the pores of the refraction decreasing layers are substantially vacuous.

According to an exemplary embodiment of the present invention, the refraction decreasing layers include one of polymer material and a glass material.

According to an exemplary embodiment of the present invention, the refraction decreasing layer closest to the base layer has a 0.001 to 0.3 lower refractive index than does the base layer.

According to an exemplary embodiment of the present invention, the base layer includes triacetate cellulose (TAC).

In an exemplary embodiment of the present invention, the base layer has a refractive index ranging from 1.3 to 1.7.

According to an exemplary embodiment of the present invention, the refraction decreasing layer farthest from the base layer contacts air, and has a 0.001 to 0.3 higher refractive index than air does.

According to an exemplary embodiment of the present invention, an average refractive index change of the plurality of refraction decreasing layers ranges from 0.0001 to 0.5 per 1 μm thickness.

In an exemplary embodiment of the present invention, the overall thickness of the plurality of refraction decreasing layers ranges from 0.05 μm to 150 μm.

According to an exemplary embodiment of the present invention, the base layer has a substantially equivalent material and configuration relative to the plurality of refraction decreasing layers, and has a higher refractive index than does the plurality of refraction decreasing layers.

The foregoing and/or other exemplary embodiments of the present invention are achieved by providing a polarizing member, including: a base film; a polarizer that is disposed on the base film; a refractive index decrement film that is disposed on the polarizer, the refractive index decrement film including a base layer disposed on the polarizer, and a plurality of refraction decreasing layers formed on the base layer and having different respective refractive indices, with the refraction decreasing layers closer to the base layer having a relatively high refractive index and the refraction decreasing layers farther from the base layer having a relatively low refractive index.

According to an exemplary embodiment of the present invention, the refraction decreasing layers have porous structure.

In an exemplary embodiment of the present invention, the refraction decreasing layers closer to the base layer have a relatively low density of pores, while the refraction decreasing layers farther from the base layer have a relatively high density of pores.

According to an exemplary embodiment of the present invention, the pores that are formed in the refraction decreasing layers are filled with at least one of air and an inert gas.

According to an exemplary embodiment of the present invention, the pores formed in the refraction decreasing layers are substantially vacuous.

In an exemplary embodiment of the present invention, the refraction decreasing layer closest to the base layer has a 0.001 to 0.3 lower refractive index than does the base layer.

According to an exemplary embodiment of the present invention, the base layer of the refractive index decrement film, the base film and the polarizer have a refractive index ranging from 1.3 to 1.7, respectively.

In an exemplary embodiment of the present invention, the refraction decreasing layer farthest from the base layer contacts air, and has 0.001 to 0.3 higher refractive index than air does.

According to an exemplary embodiment of the present invention, the average refractive index change of the plurality of refraction decreasing layers ranges from 0.0001 to 0.5 per 1 μm thickness.

In an exemplary embodiment of the present invention, the base layer has substantially equivalent material and configuration relates to the plurality of refraction decreasing layers, but has a higher refractive index than does the plurality of refraction decreasing layers.

According to an exemplary embodiment of the present invention, the polarizer includes polyvinylalcohol (PVA).

The foregoing and/or other aspects of exemplary embodiments of the present invention are achieved by providing a display device, including: a display panel that displays an image thereon; a backlight assembly that supplies light to the display panel; a pair of polarizing members that are disposed on an image display surface of the display panel and on a rear surface of the display panel facing the backlight assembly, respectively, the polarizing member that is disposed on the image display surface of the display panel including a base film, a polarizer disposed on the base film and a refractive index decrement film disposed on the polarizer, the refractive index decrement film including a base layer disposed on the polarizer and a plurality of refraction decreasing layers formed on the base layer and having different refractive indices, with the refraction decreasing layers closer to the base layer having a relatively high refractive index, while the refraction decreasing layers farther from the base layer having a relatively low refractive index.

According to an exemplary embodiment of the present invention, the refraction decreasing layers have a porous structure.

According to an exemplary embodiment of the present invention, the refraction decreasing layers closer to the base layer have relatively low density of pores, while the refraction decreasing layers farther from the base layer have a relatively high density of pores.

In an exemplary embodiment of the present invention, the pores that are formed in the refraction decreasing layers are filled with at least one of air and an inert gas.

According to an exemplary embodiment of the present invention, the pores formed in the refraction decreasing layers are substantially vacuous.

In an exemplary embodiment of the present invention, the refraction decreasing layer closest to the base layer has a 0.001 to 0.3 lower refractive index than the base layer does.

According to an exemplary embodiment of the present invention, the base layer of the refractive index decrement film, the base film and the polarizer have a refractive index ranging from 1.3 to 1.7, respectively.

In an exemplary embodiment of the present invention, the refraction decreasing layer farthest from the base layer contacts air, and has a 0.001 to 0.3 higher refractive index than air does.

According to an exemplary embodiment of the present invention, the average refractive index change of the plurality of refraction decreasing layers ranges from 0.0001 to 0.5 per 1 μm thickness.

In an exemplary embodiment of the present invention, the base layer has substantially equivalent material and configuration relative to the plurality of refraction decreasing layers, but has a higher refractive index than does the plurality of refraction decreasing layers.

The foregoing and/or other aspects of exemplary embodiments of the present invention are achieved by providing a display device, including: a display panel that displays an image thereon; a refractive index decrement film that is disposed on an image display surface of the display panel, the refractive index decrement film including a base layer disposed on the display panel and a plurality of refraction decreasing layers formed on the base layer and having different respective refractive indices, with the refraction decreasing layers closer to the base layer having a relatively high refractive index, while the refraction decreasing layers farther from the base layer having a relatively low refractive index.

According to an exemplary embodiment of the present invention, the refraction decreasing layers have a porous structure.

In an exemplary embodiment of the present invention, the refraction decreasing layers closer to the base layer have a relatively low density of pores, while the refraction decreasing layers farther from the base layer have a relatively high density of pores.

According to an exemplary embodiment of the present invention, the pores that are formed in the refraction decreasing layers are filled with at least one of air and an inert gas.

In an exemplary embodiment of the present invention, the pores formed in the refraction decreasing layers are substantially vacuous.

According to an exemplary embodiment of the present invention, the refraction decreasing layer closest to the base layer has a 0.001 to 0.3 lower refractive index than the base layer does.

According to an exemplary embodiment of the present invention, the base layer has a refractive index ranging from 1.3 to 1.7.

In an exemplary embodiment of the present invention, the refraction decreasing layer farthest from the base layer contacts air, and has a 0.001 to 0.3 higher refractive index than air does.

According to an exemplary embodiment of the present invention, the average refractive index change of the plurality of refraction decreasing layers ranges from 0.0001 to 0.5 per 1 μm thickness.

In an exemplary embodiment of the present invention, the base layer has substantially equivalent material and configuration relative to the plurality of refraction decreasing layers, and has a higher refractive index than does the plurality of refraction decreasing layers.

According to an exemplary embodiment of the present invention, the display panel includes one of a plasma display panel (PDP), an organic light emitting diode (OLED) display panel, and a field emission display (FED) panel.

### BRIEF DESCRIPTION OF THE DRAWINGS

Exemplary embodiments of the present invention will be understood in more detail from the following descriptions taken in conjunction with the accompanying drawings, of which:

FIG. 1 is a sectional view of a refractive index decrement film according to an exemplary embodiment of the present invention;

FIG. 2 is a sectional view of a polarizing member according to an exemplary embodiment of the present invention;

FIG. 3 is an exploded perspective view of a display device according to an exemplary embodiment of the present invention; and

FIG. 4 is a partially exploded perspective view of a display device according to an exemplary embodiment of the present invention.

### DETAILED DESCRIPTION OF EXEMPLARY EMBODIMENT

Hereinafter, exemplary embodiments of the present invention will be described with reference to accompanying drawings, wherein like numerals refer to like elements and repetitive descriptions will be avoided as necessary.

To clarify the present invention, unrelated descriptions are avoided.

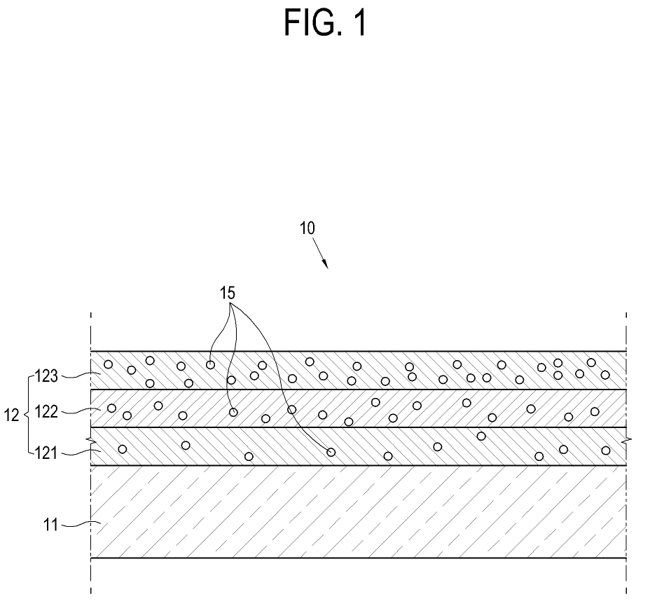

FIG. 1 is a sectional view of a refractive index decrement film 10 according to an exemplary embodiment of the present invention.

As shown therein, the refractive index decrement film 10 includes a transparent base layer 11, and a plurality of refraction decreasing layers 12 that is arranged on the base layer 11. In this exemplary embodiment, the plurality of refraction decreasing layers 12 has different respective refractive indices.

The base layer 11 is formed of a transparent material to have high light transmissivity. The transparent material may include triacetate cellulose (TAC). The base layer 11 has a refractive index ranging from 1.3 to 1.7, which is typical for materials that could be used to form the base layer 11, and is typical for a surface of a device employing the refractive index decrement film 10.

The refraction decreasing layers 12 are porous and have many small pores 15 formed therein. The refraction decreasing layers 12 may be formed of polymer material, glass material, and the like. The polymer material includes acrylic resin, fluororesin, polystyrene resin, epoxy resin, polyester resin, etc. That is, the refraction decreasing layers 12 may include porous resin and porous glass. The materials of the refraction decreasing layers 12 have a substantially similar refractive index to that of the base layer 11.

The pores 15 that are formed in the refraction decreasing layers 12 may be filled with at least one of air and an inert gas. On the other hand pores 15 of the refraction decreasing layers 12 may be substantially vacuous.

The refraction decreasing layers 12 that are closer to the base layer 11 have a relatively high refractive index, while the refraction decreasing layers 12 that are farther from the base layer 11 have a substantially low refractive index. That is, the closer the refraction decreasing layers 12 are to the base layer 11, the higher their refractive index.

If the distribution density of pores 15 formed in the refraction decreasing layers 12 is adjusted, the refractive index of the plurality of refraction decreasing layers 12 may be changed gradually. That is, the refraction decreasing layers 12 that are closer to the base layer 11 have a relatively low distribution density of pores 15, while the refraction decreasing layers 12 that are farther from the base layer 11 have a relatively high distribution density of pores 15.

If the refraction decreasing layers 12 have a large number of pores 15 formed therein, the refractive index becomes closer to that of air, that is, it becomes closer to 1. Meanwhile, if the refraction decreasing layers 12 have a small number of pores 15 formed therein, the refractive index becomes closer to that of the material used to form the refraction decreasing layers 12, that is, it becomes closer to the refractive index of the base layer 11.

A first refraction decreasing layer 121 is the refraction decreasing layer closest to the base layer 11. A third refraction decreasing layer 123 is the refraction decreasing layer farthest from the base layer 11. Second refraction decreasing layers 122 are disposed between the first and third refraction decreasing layers 121 and 123 and only one such layer 122 is shown in FIG. 1. A first surface of the third refraction decreasing layer 123 contacts the air, while a second surface thereof contacts the second refraction decreasing layer 122. The second refraction decreasing layers 122 may include multiple layers, as noted above.

The refractive index of the first refraction decreasing layer 121 is lower than that of the base layer 11 by as much as 0.001 to 0.3. The refractive index of the third refraction decreasing layer 123 is higher than that of air, that is, 1, by as much as 0.001 to 0.3.

The refractive index of the second refraction decreasing layer 122 is 0.001 to 0.3 lower than that of the first refraction decreasing layer 121, and is 0.001 to 0.3 higher than that of the third refraction decreasing layer 123.

If there is a plurality of second refraction decreasing layers 122, the second refraction decreasing layers 122 that are closer to the first refraction decreasing layer 121 have higher refractive indices. The refractive indices of the second refraction decreasing layers 122 may increase as much as 0.001 to 0.3 per each second refraction layer 122 that is close to the first refraction decreasing layer 121.

The average refractive index change of the plurality of refraction decreasing layers 12 is 0.0001 to 0.5 per 1 μm thickness. The overall thickness of the plurality of refraction decreasing layers 12 ranges from 0.05 μm to 150 μm.

That is, a plurality of refraction decreasing layers 12 having different refractive indices are used, thereby gradually changing the refractive indices and minimizing light reflection due to abrupt changes in refractive indices.

FIG. 1 illustrates the refractive index decrement film 10 that includes three refraction decreasing layers 12, but the film is not limited thereto. Alternatively, the refractive index decrement film 10 according to exemplary embodiments of the present invention may include two or four and more refraction decreasing layers 12. If the number of the refraction decreasing layers 12 of the refractive index decrement film 10 increases, and if the refractive indices of the respective refraction decreasing layers 12 are varied, the undesired reflection of light passing through the refraction decreasing layers 12 to the base layer 11 decreases.

With the foregoing configuration, the refractive index decrement film 10 may efficiently prevent undesired reflection of the light passing through the refraction decreasing layers 12 to the base layer 11.

Thus, the refractive index decrement film 10 may be utilized to reduce the reflection rate of light due to refractive index differences from air. That is, the refractive index decrement film 10 may be employed in a polarizing member attached to a liquid crystal display (LCD) panel, or may be attached to an image displaying surface of a display panel such as a plasma display panel (PDP), an organic light emitting diode (OLED) display panel and a field emission display (FED) panel.

The material and configuration of the base layer 11 in FIG. 1 are different from those of the refraction decreasing layers 12, but is not limited thereto. Alternatively, the base layer 11 may have substantially an equivalent material and configuration relative to the refraction decreasing layers 12. That is, the base layer 11 may also be porous. In this case, the base layer 11 has a higher refractive index than does the plurality of refraction decreasing layers 12. The distribution density of pores (not shown) formed in the base layer 11 is lower than the distribution density of the pores 15 of the plurality of refraction decreasing layers 12.

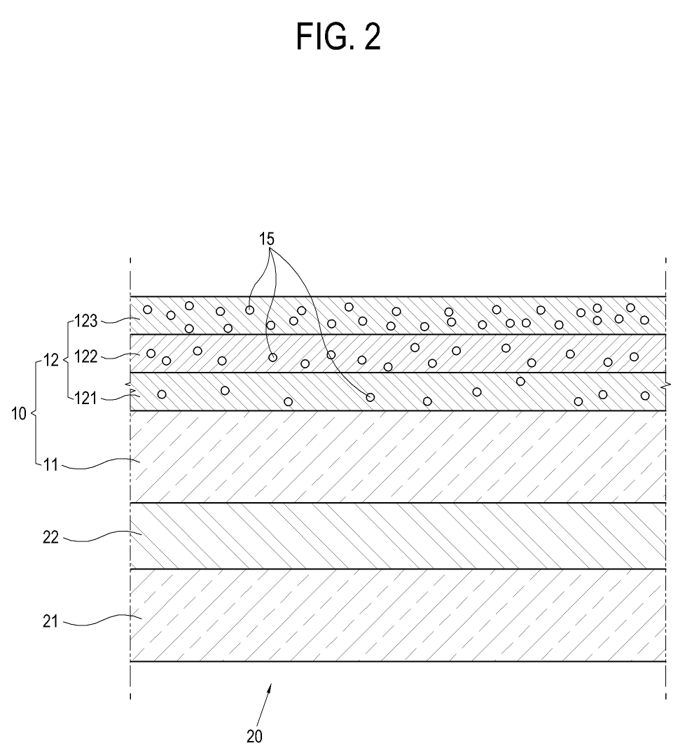

A polarizing member according to an exemplary embodiment of the present invention will be described with reference to FIG. 2. FIG. 2 is a sectional view of a polarizing member 20 that includes the refractive index decrement film 10 in FIG. 1.

As shown therein, the polarizing member 20 includes a base film 21, a polarizer 22 that is formed on the base film 21 and the refractive index decrement film 10 formed on the polarizer 22.

The refractive index decrement film 10 is the same as that shown in FIG. 1. The base layer 11 of the refractive index decrement film 10 is adjacent the polarizer 22.

The polarizer 22 may include polyvinylalcohol (PVA).

Like the base layer 11 of the refractive index decrement film 10, the base film 21 may include triacetate cellulose (TAC). That is, the base film 21 and the base layer 11 of the refractive index decrement film 10 have substantially equivalent material.

The base layer 11 of the refractive index decrement film 10, the polarizer 22 and the base film 21 have a refractive index ranging from 1.3 to 1.7, respectively. That is, the base layer 11 of the refractive index decrement film 10, the polarizer 22, and the base film 21 have substantially similar refractive indices. By using the substantially similar refractive indices, light is not reflected by differences between the refractive indices, or the amount of the reflected light is so small it can be ignored.

With the foregoing configuration, the polarizing member 20 may minimize the reflection of light that passes through the refractive index decrement film 10 and the polarizer 22 to the base film 21. The refractive index decrement film 10 is disposed between air and the polarizer 22 having relatively large differences in refractive indices therebetween to gradually decrease the refractive index differences. Thus, unnecessary light reflection due to the refractive index differences may be efficiently decreased.

The polarizing member 20 including the refractive index decrement film 10 may be attached to a liquid crystal display (LCD) panel.

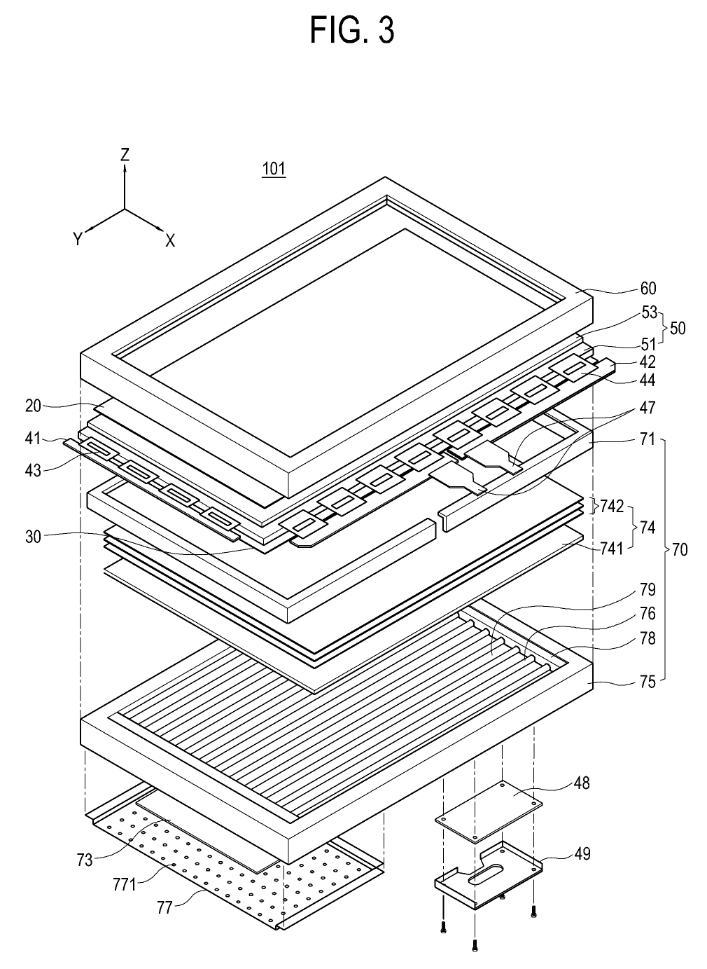

A display device according to an exemplary embodiment of the present invention will be described with reference to FIG. 3. FIG. 3 illustrates a display device 101 that includes the polarizing member 20 in FIG. 2.

As shown therein, the display device 101 includes a backlight assembly 70 that supplies light, a display panel 50 that receives light from the backlight assembly 70 and displays an image thereon, and a pair of polarizing members 20 and 30 that are respectively disposed ahead of an image display part and behind a rear surface of the display panel 50 facing the backlight assembly 70. The display device 101 further includes a fastening member 60 to fasten and support the display panel 50 to the backlight assembly 70, and other elements.

The first polarizing member 20 refers to the polarizing member that is disposed ahead of the display panel 50 while the second polarizing member 30 refers to the polarizing member that is disposed behind the display panel 50.

The first polarizing member 20 is the same as that shown in FIG. 2. That is, the first polarizing member 20 includes a base film 21, a polarizer 22 disposed on the base film 21 and a refractive index decrement film 10 disposed on the polarizer 22, as shown in FIG. 2.

The second polarizing member 30 includes a base film (not shown), a polarizer (not shown) disposed on the base film and a protection film (not shown) disposed on the polarizer.

The display device 101 includes the polarizing member 20 having the refractive index decrement film 10 attached to the front surface of the display panel 50 that displays an image. Thus, the display device 101 may prevent a contrast ratio of an image displayed on the display panel 50 from being lowered by the reflection of external light.

The display device 101 further includes a plurality of driving IC packages 43 and 44 and driving printed circuit boards (PCBs) 41 and 42 that are electrically connected with the display panel 50 and transmit a driving signal. The driving IC packages 43 and 44 may include a chip on film (COF) package or a tape carrier package (TCP).

The backlight assembly 70 includes an accommodating member 75, a light source unit 76 that is disposed within the accommodating member 75, a light source unit holder 78, a reflection sheet 79, and an optical member 74. The optical member 74 includes a diffusion plate 741 and an optical sheet 742. The backlight assembly 70 further includes a supporting member 71.

The supporting member 71 is connected with the accommodating member 75 to contain the optical member 74. The supporting member 71 supports the display panel 50 and separates the display panel 50 from the optical member 74 by a preset distance. In this way, the brightness distribution of light from the backlight assembly 70 to the display panel 50 may be more uniform.

FIG. 3 illustrates the supporting member 71 as being divided into two parts, but it is not limited thereto. Alternatively, an integrated supporting member may be used.

FIG. 3 illustrates the accommodating member 75 and the supporting member 71 as separate elements, but the structure is not limited thereto. Alternatively, the supporting member 71 may be omitted. In this case, the accommodating member 75 supports the display panel 50.

The light source unit 76 generates light to be supplied to the display panel 50. The light source unit holder 78 fastens the light source unit 76 to the accommodating member 75, and supports the optical member 74.

The reflection sheet 79 is disposed on the bottom of the accommodating member 75, and reflects the light from the light source unit 76 to the display panel 50. The light from the light source unit 76 is reflected and diffused by the reflection sheet 79, thereby improving the uniformity of the light supplied to the display panel 50.

The optical sheet 742 and the diffusion plate 741 form the optical member 74 and improve the brightness and uniformity of the light generated by the light source unit 76 that is supplied to the display panel 50. The light emitted by the light source unit 76 that is diffused and collected by the optical sheet 742 and the diffusion sheet 741 becomes substantially uniform and changes into a surface light.

An inverter circuit substrate 73 and a control circuit substrate 48 are disposed behind the accommodating member 75. The inverter circuit substrate 73 is covered by an inverter circuit substrate cover 71 that includes a plurality of heat radiating and ventilating holes 771. The control circuit substrate 48 is also covered with a control circuit substrate cover 49 and coupled with the accommodating member 75 by fasteners, such as screws.

The inverter circuit substrate 73 converts external power into a voltage at a predetermined level and supplies the converted voltage to the light source unit 76 to drive the light source unit 76. The control circuit substrate 48 is electrically connected with the driving PCB 42, and supplies a signal to display an image on the display panel 50. The control circuit substrate 42 is electrically connected with the driving PCB 42 through connection members 47.

The display panel 50 includes a first display panel 51 and a second display panel 53 facing the first display panel 51, with a liquid crystal layer (not shown) placed therebetween. The first display panel 51 refers to a rear panel while the second display panel 53 refers to a front panel. The second display panel 53 is smaller than the first display panel 51. First sides of the driving IC packages 43 and 44 are attached to a circumference of the first display panel 51 not overlapping the second display panel 53 to be connected with the display panel 50. A second side of at least one of the driving IC packages 43 and 44 is connected with the driving printed circuit boards 41 and 42.

FIG. 3 illustrates the driving IC packages 43 and 44 that are connected with the driving printed circuit boards 41 and 42, but the construction is not limited thereto. Alternatively, the driving PCB 41 that is connected with the driving IC package 43 may be omitted. In this case, a first side of the driving IC package 43 is connected with the display panel 50, while a second side thereof is not connected with any element.

Although not shown in FIG. 3, a plurality of thin film transistors (TFT), color filters, pixel electrode and common electrode are formed on the first and second display panels 51 and 53. The liquid crystal layer is interposed between the pixel electrode and the common electrode.

With the foregoing configuration, an electric field is formed between the pixel electrodes and the common electrodes if the thin film transistors, that is, the switching elements, are turned on. The alignment of liquid crystals of the liquid crystal layer disposed between the first and second display panels 51 and 53 is adjusted by the electric field. Then, a user may view a desired image with varying light transmissivity.

The display device 101 employs the polarizing member 20 including the refractive index decrement film 10, thereby efficiently preventing the contrast ratio of the image displayed on the display panel 50 from being lowered. That is, the external light is not reflected from the front surface of the display panel 50 displaying the image thereon, thereby preventing image quality, particularly the contrast ratio, from being lowered.

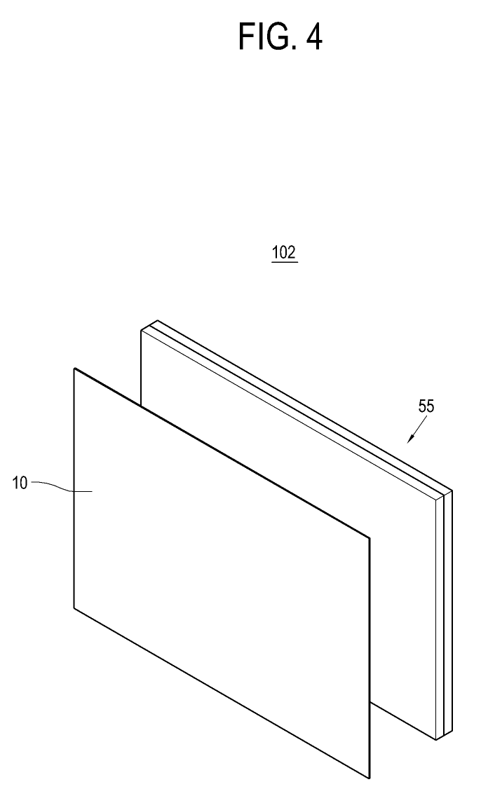

A display device according to an exemplary embodiment of the present invention will be described with reference to FIG. 4. FIG. 4 illustrates a part of a display device 102 that includes the refractive index decrement film 10 shown in FIG. 1.

As shown in FIG. 4, the display device 102 includes a display panel 55 and the refractive index decrement film 10 that is attached to an image display surface of the display panel 55.

The display panel 55 may include one of a plasma display panel (PDP), an organic light emitting diode (LED) display panel and a field emission display (FED) panel. That is, the display panel 55 may include various known PDP panels, OLED panels, and FED panels.

The refractive index decrement film 10 is the same as that shown in FIG. 1. The refractive index decrement film 10 prevents the external light from being reflected from the first side of the display panel 55 that is used for displaying the image thereon, and prevents the contrast ratio of the image from being lowered.

With the foregoing configuration, the display device 102 may efficiently prevent the contrast ratio of the image displayed on the display panel 55 from being lowered.

As described above, exemplary embodiments of the present invention provide a refractive index decrement film that minimizes a reflection rate of the external light.

That is, the refractive index decrement film may efficiently prevent light passing through a refraction decreasing layer to a base layer, from being reflected unnecessarily from the refraction decreasing layer. The refractive index decrement film may be used to reduce a reflection amount of light due to refractive index differences between the film and air.

Also, exemplary embodiments of the present invention provide a polarizing member that includes the foregoing refractive index decrement film. That is, the polarizing member may decrease reflection of light passing through the refractive index decrement film and a polarizer to a base film. The refractive index decrement film is disposed between air and the polarizer having relatively large differences in refractive indices therebetween to gradually decrease the refractive index differences. Thus, the unnecessary and undesirable reflection of light due to the refractive index differences may be efficiently reduced.

Further, exemplary embodiments of the present invention provide a display device that includes one of the foregoing refractive index decrement film and the polarizing member. That is, the display device includes the polarizing member having the refractive index decrement film to prevent the contrast ratio of an image displayed on the display panel from being lowered. More specifically, the display device may prevent external light from being unnecessarily reflected from a front surface of the display panel displaying the image thereon, and prevents image quality, particularly a contrast ratio, from being lowered.

Because the refractive index decrement film is directly attached to the display panel, the contrast ratio of the image displayed on the display panel may not be lowered.

Although exemplary embodiments of the present invention have been shown and described, it will be appreciated by those of ordinary skill in the art that changes may be made in these exemplary embodiments without departing from the principles and spirit of the present invention, the scope of which is defined in the appended claims and their equivalents.

What is claimed is:

1. A refractive index decrement film, comprising:
a transparent base layer; and
a plurality of refraction decreasing layers that is formed on the base layer, wherein the layers have different respective refractive indices, and wherein
the refraction decreasing layers closer to the base layer have a relatively high refractive index and the refraction decreasing layers farther from the base layer have a relatively low refractive index.

2. The refractive index decrement film according to claim 1, wherein the plurality of refraction decreasing layers have a porous structure.

3. The refractive index decrement film according to claim 2, wherein the refraction decreasing layers closer to the base layer have a relatively low density of pores and the refraction decreasing layers farther from the base layer have a relatively high density of pores.

4. The refractive index decrement film according to claim 3, wherein the pores of the plurality of refraction decreasing layers are filled with at least one of air and an inert gas.

5. The refractive index decrement film according to claim 3, wherein the pores of the plurality of refraction decreasing layers are substantially vacuous.

6. The refractive index decrement film according to claim 3, wherein the plurality of refraction decreasing layers comprise one of a polymer material and a glass material.

7. The refractive index decrement film according to claim 3, wherein the refraction decreasing layer closest to the base layer has a 0.001 to 0.3 lower refractive index than a refractive index of the base layer.

8. The refractive index decrement film according to claim 7, wherein the base layer comprises triacetate cellulose (TAC).

9. The refractive index decrement film according to claim 7, wherein the base layer has a refractive index ranging from 1.3 to 1.7.

10. The refractive index decrement film according to claim 3, wherein the refraction decreasing layer farthest from the base layer contacts air and has a 0.001 to 0.3 higher refractive index than a refractive index of air.

11. The refractive index decrement film according to claim 3, wherein an average refractive index change of the plurality of refraction decreasing layers ranges from 0.0001 to 0.5 per 1 μm thickness.

12. The refractive index decrement film according to claim 11, wherein an overall thickness of the plurality of refraction decreasing layers ranges from 0.05 μm to 150 μm.

13. The refractive index decrement film according to claim 3, wherein the base layer has a material and configuration substantially equivalent to the plurality of refraction decreasing layers, and has a higher refractive index than a refractive index of the plurality of refraction decreasing layers.

14. A polarizing member, comprising:
a base film;
a polarizer disposed on the base film; and
a refractive index decrement film disposed on the polarizer,
the refractive index decrement film comprising a base layer disposed on the polarizer, and a plurality of refraction decreasing layers formed on the base layer and having different respective refractive indices, wherein
the refraction decreasing layers closer to the base layer have a relatively high refractive index and the refraction decreasing layers farther from the base layer have a relatively low refractive index.

15. The polarizing member according to claim 14, wherein the plurality of refraction decreasing layers have a porous structure.

16. The polarizing member according to claim 15, wherein the refraction decreasing layers closer to the base layer have a relatively low density of pores and the refraction decreasing layers farther from the base layer have a relatively high density of pores.

17. The polarizing member according to claim 16, wherein the pores that are formed in the plurality of refraction decreasing layers are filled with at least one of air and an inert gas.

18. The polarizing member according to claim 16, wherein the pores formed in the plurality of refraction decreasing layers are substantially vacuous.

19. The polarizing member according to claim 16, wherein the refraction decreasing layer closest to the base layer has 0.001 to 0.3 lower refractive index than a refractive index the base layer.

20. The polarizing member according to claim 19, wherein the base layer of the refractive index decrement film, the base film and the polarizer have a refractive index ranging from 1.3 to 1.7, respectively.

21. The polarizing member according to claim 16, wherein the refraction decreasing layer farthest from the base layer contacts air, and has 0.001 to 0.3 higher refractive index than a refractive index of air.

22. The polarizing member according to claim 16, wherein the average refractive index change of the plurality of refraction decreasing layers ranges from 0.0001 to 0.5 per 1 μm thickness.

23. The polarizing member according to claim 16, wherein the base layer has a material and configuration substantially equivalent to the plurality of refraction decreasing layers, and has a higher refractive index than a refractive index of the plurality of refraction decreasing layers.

24. The polarizing member according to claim 16, wherein the polarizer comprises polyvinylalcohol (PVA).

25. A display device, comprising:
a display panel that displays an image thereon;
a backlight assembly that supplies light to the display panel;
a pair of polarizing members that are disposed on an image display surface of the display panel and on a rear surface of the display panel facing the backlight assembly, respectively,
the polarizing member that is disposed on the image display surface of the display panel comprising a base film, a polarizer disposed on the base film and a refractive index decrement film disposed on the polarizer,
the refractive index decrement film comprising a base layer disposed on the polarizer and a plurality of refraction decreasing layers formed on the base layer and having different refractive indices, and
the refraction decreasing layers closer to the base layer having a relatively high refractive index and the refraction decreasing layers farther from the base layer having a relatively low refractive index.

26. The display device according to claim 25, wherein the refraction decreasing layers have a porous structure.

27. The display device according to claim 26, wherein the refraction decreasing layers closer to the base layer have a relatively low density of pores and the refraction decreasing layers farther from the base layer have a relatively high density of pores.

28. The display device according to claim 27, wherein the pores formed in the refraction decreasing layers are filled with at least one of air and an inert gas.

29. The display device according to claim 27, wherein the pores formed in the refraction decreasing layers are substantially vacuous.

30. The display device according to claim 27, wherein the refraction decreasing layer closest to the base layer has 0.001 to 0.3 lower refractive index than a refractive index of the base layer.

31. The display device according to claim 30, wherein the base layer of the refractive index decrement film, the base film, and the polarizer have a refractive index ranging from 1.3 to 1.7, respectively.

32. The display device according to claim 27, wherein the refraction decreasing layer farthest from the base layer contacts air, and has a 0.001 to 0.3 higher refractive index than a refractive index of air.

33. The display device according to claim 27, wherein an average refractive index change of the plurality of refraction decreasing layers ranges from 0.0001 to 0.5 per 1 μm thickness.

34. The display device according to claim 27, wherein the base layer has a material and configuration substantially equivalent to the plurality of refraction decreasing layers, and has a higher refractive index than a refractive index of the plurality of refraction decreasing layers.

35. A display device, comprising:
a display panel that displays an image thereon; and
a refractive index decrement film disposed on an image display surface of the display panel,
the refractive index decrement film comprising a base layer disposed on the display panel and a plurality of refraction decreasing layers formed on the base layer and having different refractive indices, wherein
the refraction decreasing layers closer to the base layer have a relatively high refractive index and the refraction decreasing layers farther from the base layer have a relatively low refractive index.

36. The display device according to claim 35, wherein the refraction decreasing layers have a porous structure.

37. The display device according to claim 36, wherein the refraction decreasing layers closer to the base layer have a relatively low density of pores and the refraction decreasing layers farther from the base layer have a relatively high density of pores.

38. The display device according to claim 37, wherein the pores formed in the refraction decreasing layers are filled with at least one of air and an inert gas.

39. The display device according to claim 37, wherein the pores formed in the refraction decreasing layers are substantially vacuous.

40. The display device according to claim 37, wherein the refraction decreasing layer closest to the base layer has a 0.001 to 0.3 lower refractive index than a refractive index of the base layer.

41. The display device according to claim 40, wherein the base layer has a refractive index ranging from 1.3 to 1.7.

42. The display device according to claim 37, wherein the refraction decreasing layer farthest from the base layer contacts air, and has 0.001 to 0.3 higher refractive index than a refractive index of air.

43. The display device according to claim 37, wherein an average refractive index change of the plurality of refraction decreasing layers ranges from 0.0001 to 0.5 per 1 μm thickness.

44. The display device according to claim 37, wherein the base layer has a material and configuration substantially equivalent to the plurality of refraction decreasing layers, and has a higher refractive index than a refractive index of the plurality of refraction decreasing layers does.

45. The display device according to claim 37, wherein the display panel comprises one of a plasma display panel (PDP), an organic light emitting diode (OLED) display panel and a field emission display (FED) panel.
